(19) United States
(12) Patent Application Publication
(10) Pub. No.: US 2018/0319402 A1
(43) Pub. Date: Nov. 8, 2018

(54) SYSTEM AND METHOD FOR AUTOMATIC ACTIVATION OF DRIVER ASSISTANCE FEATURE

(71) Applicant: Ford Global Technologies, LLC, Dearborn, MI (US)

(72) Inventors: Aaron L. Mills, Ann Arbor, MI (US); John Shutko, Ann Arbor, MI (US); Shane Elwart, Ypsilanti, MI (US); Timothy D. Zwicky, Dearborn, MI (US); Nitendra Nath, Troy, MI (US); Justin Teems, Saline, MI (US)

(21) Appl. No.: 15/588,395

(22) Filed: May 5, 2017

(51) Int. Cl. B60W 30/18; B60W 10/20; B60W 10/04; B60W 40/06; B60W 50/10

(52) U.S. Cl. CPC B60W 30/18163; B60W 10/20; B60W 10/04; B60W 40/06; B60W 50/10; G01S 19/42; B60W 2520/125; B60W 2520/105; B60W 2720/10; B60W 2710/20; B60W 2550/14; B60W 2510/18

(57) ABSTRACT

Embodiments include a vehicle system comprising a display capable of displaying a message indicating automatic activation of a driver assistance feature; at least one electronic control unit configured to determine whether preset driving conditions are met; and a processor configured to cause the display to display the message upon receiving a notification indicating satisfaction of the conditions, initiate a countdown, and automatically activate the driver assistance feature upon completion of the countdown. Embodiments also include a method of activating a driver assistance feature in a vehicle. The method includes receiving, at a processor, a notification indicating satisfaction of preset driving conditions; in response, displaying, on a display, a message indicating automatic activation of the driver assistance feature; initiating a countdown, using the processor; and automatically activating the driver assistance feature, using the processor, upon completion of the countdown.

### TECHNICAL FIELD

This application generally relates to active driver assistance features in a vehicle, and more specifically, to identifying scenarios for automatically activating such features.

### BACKGROUND

Many vehicles today include some form of driver assistance technology, such as Adaptive Cruise Control (ACC), Traffic Jam Assist (TJA), Highway Assist (HA), Parking Assist, Lane Keeping Assist, Lane Departure Warning, Blind Spot Warning, Forward Collision Warning, and others. Collectively referred to as Advanced Driver Assistance Systems (ADAS), these systems help increase vehicle safety and improve the overall driving process by automating, adapting, and/or enhancing existing vehicle systems. For example, safety features may help avoid collisions and accidents by alerting the driver to potential problems or by implementing safeguards and taking over control of the vehicle when necessary. Adaptive features may illuminate blind spots, automate lighting or braking, keep the vehicle within a lane, provide parking assistance or adaptive cruise control, or alert the driver to other vehicles or objects within a predetermined vicinity.

Typically, advanced driver assistance systems monitor the vehicle environment and traffic conditions by taking measurements of objects using forward-looking radars and cameras, as well as other sensors on the vehicle. The measurements are then used to control a vehicle and/or provide feedback or warnings based on the objects in the vehicle's path. Passive driver assistance systems (e.g., Forward Collision Warning, Blind Spot Warning, and Lane Departure Warning) can provide feedback or warnings to the driver but do not control the vehicle. Active driver assistance systems (e.g., Adaptive Cruise Control, Traffic Jam Assist, Lane Keeping Assist, Parking Assist, and Highway Assist) can actively control the vehicle, as well as provide warnings to the driver. The type of active vehicle control can be longitudinal control (e.g., acceleration, deceleration, and/or braking), lateral control (e.g., lane change, lane maintenance, and/or steering), or both.

For example, adaptive cruise control (ACC) provides only longitudinal control of the vehicle. Specifically, ACC systems typically maintain the vehicle at a user-selected cruise control speed so long as no objects appear in the lane ahead of the vehicle. Upon detecting a slower vehicle, the ACC system will automatically reduce the vehicle's speed to maintain a safe following distance. Once the lane clears, or a safe distance is created between the two vehicles, the ACC system may accelerate the vehicle back to the cruise control speed.

Traffic Jam Assist (TJA), also known as “adaptive cruise control with stop and go feature,” uses a similar methodology to control the vehicle's speed based on surrounding objects. But unlike ACC, the longitudinal control provided by TJA systems includes applying the brakes to bring the vehicle to a full stop (e.g., in response to detecting stopped traffic in the lane ahead) and accelerating the vehicle when traffic starts moving again.

Lane Keeping Assist provides lateral control by steering the vehicle to help maintain the vehicle position in a current lane, and may also provide feedback or warnings when the vehicle begins to stray from its lane. Highway Assist (HA) systems combine Traffic Jam Assist, Lane Keeping Assist, and other technologies in order to provide both longitudinal control (e.g., acceleration, deceleration, and braking) and lateral control (e.g., lane maintenance) of the vehicle while driving on highways or other clearly-marked, high-speed, non-urban, intersection-free roadways.

While these and other active driver assistance features are designed to help reduce the stress or workload on the driver and improve driver awareness, in many cases, the driver does not think to activate these features. In other cases, the driver may be confused as to when the features will activate. For example, Highway Assist requires a high level of confidence in road and traffic conditions before the vehicle's system can be activated for an extended duration. This level of confidence is typically achieved by driving a given high-quality route multiple times to build an appropriate drive history. However, the driver may not know which routes qualify and which do not and therefore, would have difficulty knowing when the Highway Assist features would automatically activate.

Accordingly, there is still a need in the art for a vehicle system that can automatically activate appropriate driver assistance features in a manner that is intuitive and consistent for the driver.

### SUMMARY

The invention is intended to solve the above-noted and other problems by providing systems and methods configured to (1) automatically activate a driver assistance feature once preset driving conditions are satisfied, a message is displayed indicating that automatic activation of the driver assistance feature will occur upon completion of a countdown, and the countdown is complete, and (2) select an appropriate level of driver assistance depending on road quality information or driver preferences.

For example, one embodiment provides a vehicle system comprising a display capable of displaying a message indicating automatic activation of a driver assistance feature; at least one electronic control unit configured to determine whether preset driving conditions are met; and a processor configured to cause the display to display the message upon receiving a notification indicating satisfaction of the conditions, initiate a countdown, and automatically activate the driver assistance feature upon completion of the countdown.

Another example embodiment provides a method of activating a driver assistance feature in a vehicle. The method includes receiving, at a processor, a notification indicating satisfaction of preset driving conditions; in response, displaying, on a display, a message indicating automatic activation of the driver assistance feature; initiating a countdown, using the processor; and automatically activating the driver assistance feature, using the processor, upon completion of the countdown.

As will be appreciated, this disclosure is defined by the appended claims. The description summarizes aspects of the embodiments and should not be used to limit the claims. Other implementations are contemplated in accordance with the techniques described herein, as will be apparent to one having ordinary skill in the art upon examination of the following drawings and detail description, and such implementations are intended to within the scope of this application.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 is a block diagram showing an exemplary vehicle computing system, in accordance with certain embodiments.

FIG. 2 is a flow diagram of an example method of automatically activating a driver assistance feature, in accordance with certain embodiments.

FIG. 3 is a flow diagram of an example method of selecting an appropriate driver assistance feature, in accordance with certain embodiments.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects.

Systems and methods are provided herein for automatically activating an appropriate driver assistance feature in a vehicle traveling on a highway. As used herein, the term “highway” includes a controlled or restricted access highway, freeway, expressway, parkway, motorway, interstate, or other major roadway designed for high-speed vehicular traffic and having regulated ingress/egress and traffic flow, clear lane markings, and minimal or no traffic signals, intersections, or property access. As will be appreciated, a highway typically has one or more on-ramps or entrances and one or more off-ramps or exits.

Embodiments described herein use various forms of data, collected in real-time by one or more components of the vehicle, to determine when a vehicle is entering or exiting a highway (e.g., travelling on an on-ramp or an off-ramp) and when the vehicle has changed lanes on the highway. For example, the data can include location data obtained by a vehicle navigation system (e.g., Global Positioning System (GPS) coordinates) for a current geographical location of the vehicle, map data obtained by the vehicle navigation system for an area surrounding the vehicle, and/or real-time image data obtained by a vehicle camera system (e.g., captured images or video) as the vehicle travels on or towards the highway. Determinations made based on this data may be used to automatically activate or deactivate an automated driver assistance feature associated with highway travel, such as, for example, Highway Assist (HA), Traffic Jam Assist (TJA), or Adaptive Cruise Control (ACC).

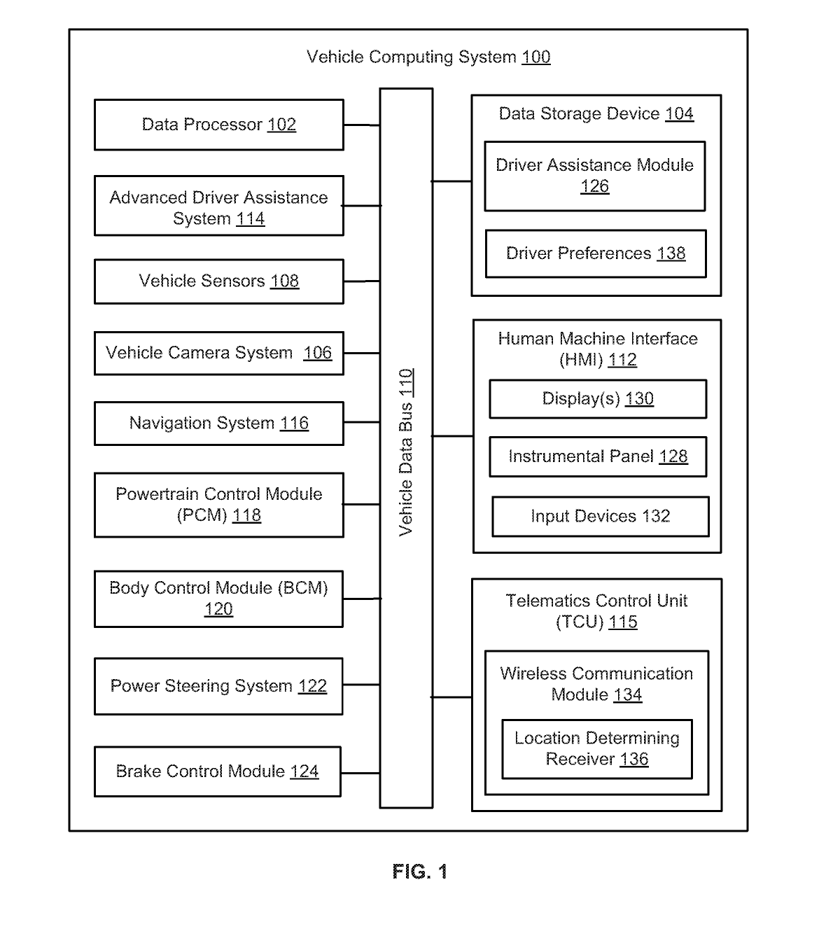

More specifically, embodiments include systems and methods configured, using a program module or software instructions (such as, e.g., driver assistance module 126 shown in FIG. 1), to automatically activate an automated driver assistance feature upon satisfaction of preset driving conditions and after completion of a countdown. The countdown can be initiated after the vehicle operator is notified of the impending activation via a message presented on a user interface of the vehicle (such as, e.g., instrument panel 128 shown in FIG. 1). The message may be presented on the user interface as a prompt offering the vehicle operator with a first user-selectable option for stopping the automatic activation of the automated driver assistance feature, and a second user-selectable option for immediately activating the automated driver assistance feature. The message may further indicate that the automated driver assistance feature will automatically activate if the vehicle operator takes no action (e.g., does not select either of the options) before the countdown is complete.

The countdown may be time-based, wherein the countdown ends after passage of a predetermined amount of time (e.g., 10 seconds), or distance-based, wherein the countdown ends after the vehicle travels a predetermined distance (e.g., 200 feet). The countdown may be stopped upon receipt of certain user inputs. For example, the countdown may be stopped upon receiving user selection of the first option to stop automatic activation of the automated driver assistance feature. As another example, the countdown may be stopped upon receiving user selection of the second option to immediately activate the automated driver assistance feature.

The preset driving conditions can include (1) determining that the vehicle is traveling on a highway and (2) determining that the vehicle has merged into a preferred lane of the highway, such as, for example, a center lane or a left lane. Satisfaction of these conditions may be determined by one or more vehicle components, such as, for example, one or more electronic control units (ECUs) of the vehicle. In some cases, satisfaction of the preset driving conditions may be determined by a data processor (e.g., processor 102 shown in FIG. 1) upon combining or comparing outputs received from the one or more ECUs. As an example, the one or more ECUs may include the vehicle navigation system, the vehicle camera system, and/or an advanced driver assistance system (ADAS). In one embodiment, the ADAS may be configured to collect data from the navigation and/or camera systems and identify lane change events, including a highway merge event, based on the collected data.

In embodiments, the automated driver assistance feature automatically activated at the end of the countdown may be any automated feature associated with highway travel, such as, for example, Highway Assist (HA), Traffic Jam Assist (TJA), or Adaptive Cruise Control (ACC). The exact automated feature to be activated at the end of the countdown can vary depending on the type of vehicle, the type of driver assistance features included in the advanced driver assistance system of the vehicle, whether certain parameters associated with a given feature have been met, and whether the vehicle operator has made driver preference selections.

In some embodiments, a vehicle processor (e.g., data processor 102 shown in FIG. 1) can select which driver assistance feature to activate based on data collected by the ADAS or other ECU, such as, for example, road quality data and how long the vehicle operator is operating the vehicle hands free (e.g., not touching the steering wheel), as well as driver preferences information stored in a vehicle memory (e.g., data storage device 104 shown in FIG. 1). The road quality data may include, for example, a quality of lane markings on the highway, road curvature information, and other data related to a road condition of the highway. The driver preferences information may include, for example, whether a Lane Centering feature has been selected, whether lateral control is allowed, and if so, the level of lateral control allowed.

In embodiments, the vehicle may continue to monitor the vehicle environment after activation of the automated driver assistance feature and may deactivate the feature upon determining that the preset driving conditions are no longer satisfied. For example, if the vehicle exits the highway or changes to a different (e.g., non-preferred) lane, the automated feature may be deactivated. The automated driver assistance feature may also be deactivated upon receiving an override command from at least one ECU. As an example, the override command may be a braking event triggered by the vehicle operator pressing the brake pedal, an acceleration event triggered by the vehicle operator pressing on the gas pedal, or a lane change event triggered by the vehicle operator turning on a turn signal, steering the vehicle out of a current lane, and/or touching the steering wheel. After deactivating the automated feature, the vehicle may return to monitoring the vehicle environment to determine whether the preset driving conditions have been met, so that the automated driver assistance feature can be re-activated once conditions stabilize.

FIG. 1 illustrates an example vehicle computing system (VCS) 100 (also referred to herein as “vehicle system”) for carrying out the techniques disclosed herein. The VCS 100 may be included in any type of vehicle. In embodiments, the vehicle computing system 100 may be part of a vehicle electronics system or an infotainment system of the vehicle, such as the SYNC® system manufactured by FORD MOTOR COMPANY®. Other embodiments of the VCS 100 can include different, fewer, or additional components than those described below and shown in FIG. 1.

As shown, the VCS 100 includes a data processor 102, a data storage device 104, a vehicle camera system 106, vehicle sensors 108, and a vehicle data bus 110. The VCS 100 can further include various electronic control units (ECUs) that are responsible for monitoring and controlling the electrical systems or subsystems of the vehicle. Each ECU may include, for example, one or more inputs and outputs for gathering, receiving, and/or transmitting data, a memory for storing the data, and a processor for processing the data and/or generating new information based thereon. In the illustrated embodiment, the ECUs of the VCS 100 include a human-machine interface (HMI) 112, an advanced driver assistance system (ADAS) 114, a telematics control unit (TCU) 115, a navigation system 116, a powertrain control module (PCM) 118, a body control module (BCM) 120, an electric power steering system 122, and a brake control module 124. Though not shown, the VCS 100 may include other ECUs, such as, for example, a restraint control module (RCM) for controlling and monitoring a restraint system of the vehicle 100.

The ECUs of the VCS 100 are interconnected by the vehicle data bus 110 (such as, e.g., a controller area network (CAN) bus), which passes data to and from the various ECUs and other components of the VCS 100, such as the vehicle sensors 108, as well as other vehicle and/or auxiliary components in communication with the VCS 100. Further, the data processor 102 can communicate with any one of the ECUs, the sensors 108, and the data storage device 104 via the data bus 110 in order to carry out one or more functions, including the functions associated with the ADAS 114 and/or a driver assistance module 126.

The vehicle camera system 106 can include a plurality of cameras positioned at various locations on the vehicle, such as, for example, front, rear, left, and/or right sides of the vehicle, in order to capture one or more field(s) of view. The cameras of the camera system 106 may be video cameras, still-image cameras, and/or any other suitable type of camera. In some cases, the vehicle camera system 106 can be implemented as an electronic control unit (ECU) comprising a separate memory for storing program modules or software instructions for carrying out image processing techniques related to generating the desired field(s) of view and/or extracting desired information from the captured images or video, and a separate processor for executing the instructions stored in the ECU memory.

In embodiments, the vehicle camera system 106 can provide raw image data and/or processed data to the processor 102, the ADAS 114, and/or the driver assistance module 126 in order to carry out functions described herein. For example, the camera system 106 may include a graphics processing unit (GPU) or other image processor configured to analyze the image data captured by the cameras using feature extraction, image registration, object recognition, identification, or detection, and other image processing techniques, and to output information extracted from, or determined based on, the image data. The camera system 106 may be used to detect lane markings included the field of view of the cameras, and the marking information may be used by the ADAS 114 to provide lane keeping assistance, lane departure warnings, lane centering assist, or parking assist, and/or by the driver assistance module 126 to detect when the vehicle changes lanes and/or merges onto a highway. The camera system 106 may also be used to detect traffic signals or signs on the road (e.g., a highway plaque), turn signals or brake lights on other vehicles, and other traffic indicators that can be used by the ADAS 114 to provide driver assistance. In some cases, the camera system 106 may be used to detect other vehicles on the road as well.

The vehicle sensors 108 can include various sensors for detecting objects (e.g., other vehicles or large obstacles) adjacent to or near the vehicle, within a path of the vehicle, and/or moving towards the vehicle. For example, the vehicle sensors 108 can use radar, laser, infrared, and/or ultrasound technology for detecting the range, speed, and azimuth of a target object, and/or a distance between the vehicle and an object within the vehicle path. The vehicle sensors 108 may be positioned at various locations around the vehicle in order to detect objects within a forward, reverse, and/or lateral path of the vehicle.

In some embodiments, the vehicle sensors 108 can also include dynamic sensors or any other type of sensor for detecting, monitoring, and/or measuring a current movement of the vehicle. For example, the dynamic vehicle sensors 108 can include wheel speed sensors, lateral acceleration sensors, longitudinal acceleration sensors, steering wheel sensors, steering angle sensors, and yaw rate sensors. In such cases, the outputs of the dynamic vehicle sensors 108 can used to determine the vehicle's current movement status, including, for example, yaw rate, longitudinal and lateral acceleration, pitch and roll rates, etc.

In embodiments, the information obtained by the vehicle sensors 108 may be provided to the processor 102 and/or the ADAS 114 to implement various types of driver assistance, including, for example, adaptive cruise control, traffic jam assist, parking assist, lane change assist, forward collision warning, rear crash avoidance, blind spot warning, etc. In some cases, the camera system 106 may be used in conjunction with the vehicle sensors 108 to implement one or more features of the ADAS 114 and/or the driver assistance module 126. For example, the Traffic Jam Assist feature of the ADAS 114 may identify a need to slow down or stop the vehicle upon determining that the information captured by the camera system 106 shows brake lights on the vehicle in the lane ahead, and may confirm the need to slow down or stop using distance and/or speed information obtained from the vehicle sensors 108 for the vehicle in the lane ahead. In some cases, the vehicle sensors 108 can include camera-based sensors for implementing the advanced image processing techniques.

The human-machine interface (HMI) 112 (also referred to as a “user interface”) can be an ECU for enabling user interaction with the vehicle and for presenting vehicle information and other data to the vehicle operator in accordance with the techniques described herein, including those associated with the ADAS 114 and/or driver assistance module 126. The HMI 112 can comprise an instrument panel (IP) 128, one or more display screens 130 (e.g., media display screen, navigation display screen, infotainment display screen, etc.), a plurality of input devices 132, and various other devices for inputting, entering, receiving, capturing, displaying, or outputting data associated with the vehicle computing system 100, the vehicle camera system 106, the navigation system 116, the advanced driver assistance system 114, the driver assistance module 126, and/or other techniques disclosed herein. According to embodiments, the input devices 132 can include, for example, one or more of a keyboard, keypad, pointing device (e.g., electronic or optical mouse), button or push button, slider, switch, knob, dial, touch input device, microphone, voice or speech recognition module, and any other type of input device. The HMI 112 can be configured to interact with the other ECUs of the VCS 100 and/or the data processor 102 via the data bus 110 in order to provide information or inputs received via the HMI 112 to an appropriate component of the VCS 100 and to present, to the vehicle operator, information or outputs received from the various components of the VCS 100, including the ADAS 114 and the driver assistance module 126, for display on one of the display screens 130 and/or the IP 128.

In embodiments, the instrument panel 128 (also referred to as a “dashboard” or “cluster”) includes a control panel positioned in front of the driver's seat for housing instrumentation and controls for operation of the vehicle 100, including, for example, a steering wheel, various gauges (e.g., speedometer, odometer, fuel gauge, etc.), and various vehicle indicators, such as, for example, a selected position of a gear selector, seat belt warnings, low fuel, low tire pressure, etc. In some cases, the instrument panel 128 includes a display screen for electronically or digitally displaying the various gauges, or values related thereto, and the various vehicle indicators. In some such cases, the ADAS 114 and/or the driver assistance module 126 may send information to the IP 128, via the vehicle data bus 110, for display on the display screen of the IP 128.

In some embodiments, a message indicating impending activation of an automated driver assistance feature, and the countdown associated therewith, can be displayed on the display screen of the instrument panel 128. In such cases, the instrument panel 128 may also include one or more input devices 132 for activating or deactivating the automated driver assistance feature, such as, for example, a “Set” or “Resume” button for activating the feature, a “Cancel” for deactivating the feature, and an “Off” button for turning off or disabling the feature.

The one or more display screens 130 can be separate from the instrument panel 128 and can be configured to display other vehicle information, such as, for example, navigation system information, audio system information, video and/or images currently captured by the external vehicle camera system 106, image(s) captured by an in-vehicle camera (not shown), heating and air/conditioning information, etc. In embodiments, the VCS 100 may provide information obtained from the ADAS 114 and/or the driver assistance module 126 to the one or more display screens 130 for display thereon.

The telematics control unit (TCU) 115 is an ECU for enabling the VCS 100 to connect to one or more wireless networks, such as, for example, WiFi, WiMax, cellular (e.g., GSM, GPRS, LTE, 3G, 4G, CDMA, etc.), Bluetooth, near-field communication (NFC), radio-frequency identification (RFID), satellite, dedicate short-range communication (DSRC), Global Positioning System (GPS), and infrared networks. In embodiments, the TCU 115 (also referred to as a “vehicle telematics unit”) includes a wireless communication module 134 comprising one or more antennas, modems, receivers, and/or transmitters (not shown) for connecting to the various wireless networks. The TCU 115 can receive external data via the wireless communication module 134 and provide the external data to an appropriate ECU of the VCS 100. In some cases, the TCU 115 may also receive internal data from other ECUs of the VCS 100 and/or the data processor 102 with instructions to transmit the internal data to, for example, a nearby vehicle or a remote server.

As shown in FIG. 1, the wireless communication module 134 can include a location-determining receiver 136 for providing location data (e.g., longitudinal coordinates, latitudinal coordinates, altitude/elevation measurements, etc.) for the vehicle and/or its surrounding area to the data processor 102, the navigation system 116, the driver assistance module 126, and/or the ADAS 114 via the data bus 110. The location-determining receiver 136 can be configured to use satellite signals, terrestrial signals, or both to determine a current, or present, location or position of the vehicle, and to control tracking of the vehicle using latitude and longitude values obtained from the satellite. In embodiments, the location-determining receiver 136 may be a GPS receiver, a Global Navigation Satellite System (GNSS) receiver, or other satellite-based receiver for precisely determining a current geographic location of the vehicle. In some cases, the location-determining receiver 136 may use various satellite signals to triangulate the position of the vehicle.

The wireless communication module 134 may also include a mobile communication unit (not shown) for wirelessly communicating over a cellular network (e.g., GSM, GPRS, LTE, 3G, 4G, CDMA, etc.), an 802.11 network (e.g., WiFi), a WiMax network, and/or a satellite network. In some cases, the wireless communication module 134 includes a dedicated short range communication (DSRC) transceiver (not shown) for facilitating wireless communication with nearby vehicles (e.g., using vehicle-to-vehicle (V2V) protocols) and/or roadside infrastructure (e.g., using vehicle-to-infrastructure (V2I) protocols) over a DSRC network.

The navigation system 116 can be an ECU for monitoring and/or obtaining vehicle location data, route information, map data, and other geographical information from the location-determining receiver 136. The navigation system 116 may be communicatively coupled to the location-determining receiver 136 via the vehicle data bus 110. In addition, the navigation system 116 can be communicatively coupled to one of the display screens 130 for displaying route information, map data, and a current position of the vehicle to a vehicle operator.

In embodiments, the navigation system 116 may receive commands from the ADAS 114, via the vehicle data bus 110, in association with carrying out certain driver assistance features. For example, the navigation system 116 may receive commands to provide a current vehicle position during implementation of parking assist, lane changing assist, traffic jam assist, and/or other ADAS features. In some cases, the navigation system 116 may send location data to the ADAS 114 and/or the driver assistance module 126, via the vehicle data bus 110, for use in implementing certain driver assistance features. For example, the driver assistance module 126 and/or the processor 102 may use the location data to determine whether the vehicle has entered a highway on-ramp and/or whether the vehicle has entered a preferred lane of the highway, in satisfaction of preset driving conditions associated with automatic activation of a driver assistance feature.

The powertrain control module (PCM) 118 is an ECU for controlling and monitoring the engine and transmission of the vehicle. In some embodiments, the PCM 118 can be separated into two separate ECUs, specifically an engine control unit and a transmission control unit. In either case, the PCM 118 can be configured to control starting and stopping of the engine of the vehicle, as well as control acceleration and/or deceleration of the vehicle. In addition, the PCM 118 can include, or be coupled to, a gear selector (also known as a “gearshift”) for changing a gear of the vehicle between, for example, park (“P”), reverse (“R”), neutral (“N”), drive (“D”), and low gear (“L”). The PCM 118 can also include or be coupled to an ignition switch sensor for detecting a position of the ignition switch, where the ignition switch can be moved between, for example, an ignition “ON” position, an ignition “OFF position, a “start” (or crank) position, a “lock” position, and an “accessory” (or battery) position.

In embodiments, the PCM 118 may receive commands from the ADAS 114, via the vehicle data bus 110, in association with carrying out certain driver assistance features. For example, the PCM 118 may receive commands to accelerate or decelerate the vehicle during implementation of parking assist, lane changing assist, traffic jam assist, and/or other ADAS features. In some cases, the PCM 118 may send data about one or more vehicle components to the ADAS 114 and/or the driver assistance module 126, via the vehicle data bus 110, for use in implementing certain driver assistance features. For example, the PCM 114 may be configured to provide a gear selector position, an ignition switch position, and/or acceleration/deceleration information to the ADAS 114 and/or to the data processor 102 for processing by the driver assistance module 126. In the case of an acceleration event, if the automated driver assistance feature is activated, the acceleration event may cause the driver assistance module 126 to deactivate the feature.

The body control module (BCM) 120 is an ECU for controlling and monitoring various electronic accessories in a body of the vehicle. In embodiments, the BCM 120 can control the doors of the vehicle, including locking, unlocking, opening, and/or closing said doors. In some embodiments, the BCM 120 also controls the power windows, power roof (e.g., moonroof, sunroof, convertible top, etc.), headlights, tail lights, turn signals, and any other exterior lights of the vehicle, and interior lighting of the vehicle. The BCM 120 may also control other electronically-powered components in the body of the vehicle, such as, for example, air-conditioning units, power mirrors (including side rear view mirrors), and power seats. In some embodiments, the BCM 120 can be configured to implement vehicle commands received from the ADAS 114, via the vehicle data bus 110, that are related to controlling operation of the headlights, turning signals, rearview mirrors, or other vehicle components controlled by the BCM 120. In some cases, the BCM 120 can be configured to send data about one or more vehicle components (e.g., turn signals) to the ADAS 114, via the vehicle data bus 110, for use in implementing certain driver assistance features.

The power steering system 122 is an ECU for monitoring and/or controlling a steering or turning of one or more wheels of the vehicle. In some embodiments, the power steering system 122 can be configured to carry out vehicle commands related to steering the vehicle received from the ADAS 114, via the vehicle data bus 110, for example, to implement lane keeping assist, parking assist, or lane change features. In some cases, the power steering system 122 can be configured to send data related to steering of the vehicle to the ADAS 114 and/or the driver assistance module 126, via the vehicle data bus 110, for use in implementing certain driver assistance features. For example, the power steering system 122 may send steering data indicating a lane change to the driver assistance module 126. The lane change information may be used by the driver assistance module 126 to determine that the vehicle is situated in a preferred lane and ready for automatic activation of a driver assistance feature. However, if the automated feature is already activated, the lane change event may cause the driver assistance module 126 to deactivate the automated feature.

The brake control module 124 is an ECU for monitoring and/or controlling a braking system of the vehicle, including the braking, deceleration, slowing, or stopping of the vehicle. In some embodiments, the brake control module 124 can be configured to carry out vehicle commands related to the vehicle brakes received from the ADAS 114, via the vehicle data bus 110, for example, to implement forward collision avoidance, parking assist, and other driver assistance features. In some cases, the brake control module 124 can be configured to send braking system data to the ADAS 114 and/or the driver assistance module 126, via the vehicle data bus 110, for use in implementing certain driver assistance features. For example, if the automated driving assistance feature is activated, a braking event may cause the driver assistance module 126 to deactivate the automated feature.

The advanced driving assistance system (ADAS) 114 can be an ECU for monitoring the vehicle environment, traffic conditions, and other surroundings and when needed, implementing various driving assistance features that automate, adapt, or enhance select vehicle systems. In some cases, the ADAS 114 may be comprised of a plurality of individual systems or ECUs, each unit configured to handle a specific type of driver assistance (e.g., an ACC system, a TJA system, a Lane Keeping Assist system, a Highway Assist system, etc.). Using the vehicle data bus 110, the ADAS 114 can receive inputs (e.g., image data, detected information, measurements, etc.) from the vehicle camera system 106, the vehicle sensors 108, the navigation system 116, and/or one or more other ECUs, and can provide outputs (e.g., control commands, feedback, warning messages, etc.) to the processor 102, the HMI 112, the driver assistance module 126, and/or one or more other ECUs.

The data processor 102 can comprise one or more of a microprocessor, a microcontroller, a programmable logic array, an application-specific integrated circuit, a logic device, or other electronic device for processing, inputting, outputting, manipulating, storing, or retrieving data. In embodiments, the data processor 102 can include a central processing unit (CPU) and/or a graphics processing unit (GPU). In some embodiments, the VCS 100 can comprise a general purpose computer that is programmed with various programming instructions or modules stored in the data storage device 104 (e.g., electronic memory), or elsewhere.

The data storage device 104 can comprise one or more of electronic memory, nonvolatile random access memory (e.g., RAM), flip-flops, a computer-writable or computer-readable storage medium, a magnetic or optical data storage device, a magnetic or optical disc drive, a hard disk drive, or other electronic device for storing, retrieving, reading, or writing data. The data storage device 104 stores one or more software program modules or software instructions for execution by the data processor 102. As shown in FIG. 1, the software stored in the data storage device 104 can include the driver assistance module 126. In other cases, the driver assistance module 126 can be a stand-alone module that can be added to a vehicle's existing advanced driver assistance system, or stored in a memory thereof, in order to provide automatic activation of certain ADAS features, when appropriate.

The driver assistance module 126 can comprise software instructions that, when executed by the data processor 102, cause the data processor 102 to: request one or more ECUs for data related to one or more preset driving conditions; in response to receiving a notification indicating satisfaction of the preset driving conditions, generate a message indicating automatic activation of a driver assistance feature of the ADAS 114 upon completion of a countdown; display the message to one of the display screens 130 for display thereon; initiate the countdown; and automatically activate the driver assistance feature upon completion of the countdown. In embodiments, the notification indicating satisfaction of the preset driving conditions may be received from the ADAS 114 and/or one or more other ECUs. For example, in some cases, the ADAS 114 may use location data received from the navigation system 116 to determine whether the vehicle has merged onto a highway or has entered an on-ramp or exit ramp of a highway in accordance with a first preset driving condition. In other cases, the navigation system 116 may provide the highway entrance information directly to the data processor 102 and/or the driver assistance module 126. A second preset driving condition, merging into a preferred lane of the highway, may be determined based on lane change information obtained from the PCM 118, the BCM 120, and/or the navigation system 116.

In some embodiments, the driver assistance module 126 may also comprise software instructions that, when executed by the data processor 102, cause the data processor 102 to: stop the countdown upon receiving, via the HMI 112, user selection of a first option to cancel the automatic activation; stop the countdown and immediately initiate the driver assistance feature upon receiving, via the HMI 112, user selection of a second option to initiate the driver assistance feature; and/or deactivate the driver assistance feature upon receiving, from one or more ECUs, an override command from the vehicle operator or a second notification that the preset driving conditions are no longer satisfied. In some embodiments, the driver assistance module 126 may also be configured to select whether to control longitudinal and/or lateral movement of the vehicle based on road quality data obtained from the ADAS 114, the camera system 106, and/or the navigation system 116.

As shown in FIG. 1, the data storage device 104 may also store driver preferences information 138 entered by the vehicle operator (or user) using the HMI 112. The driver preferences information can include a user-selected level of lateral support or control to be applied when the automated driver assistance feature is active. The user may select the level of lateral support using menu options presented by the HMI 112, for example, on the display of the instrument panel 128. For example, the menu options may include “no lateral support,” selection of which would prevent the ADAS 114 from providing any lateral control of the vehicle. The menu options may also include “Traffic Jam Assist,” selection of which causes the ADAS 114 to provide lateral control as dictated by the Traffic Jam Assist feature. The menu options may also include “Highway Assist,” selection of which causes the ADAS 114 to provide lateral control as dictated by the Highway Assist feature.

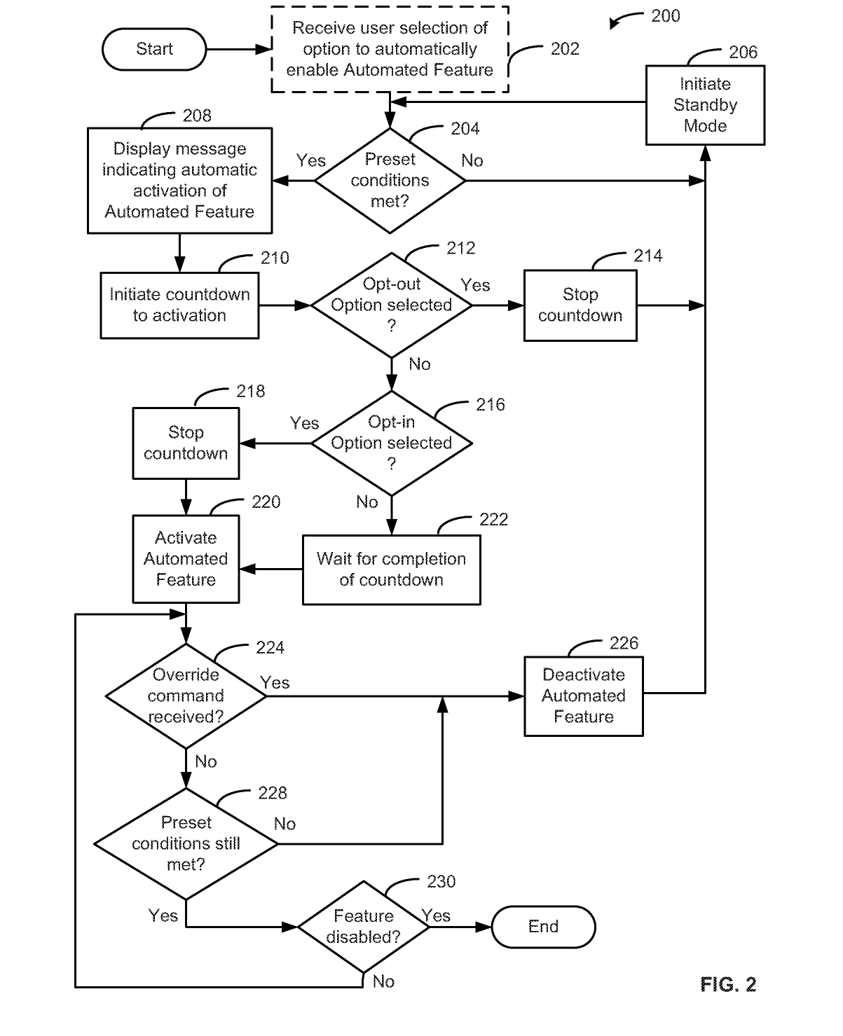

FIG. 2 illustrates an example method 200 of activating a driver assistance feature in a vehicle, in accordance with embodiments. The method 200 can be carried out by one or more processors (or controllers) included in, for example, a vehicle computing system (such as, e.g., the vehicle computing system 100 shown in FIG. 1). In one embodiment, the method 200 is implemented, at least in part, by the data processor 102 of the VCS 100 executing software stored in the data storage device 104, such as, e.g., the driver assistance module 126, and interacting with one or more components of the VCS 100, such as, e.g., the HMI 112, the ADAS 114, and/or one or more of the other ECUs.

In some embodiments, the method 200 may begin at step 202, where the processor receives user selection of an option to automatically enable an automated driver assistance feature (also referred to herein as an “Automated Feature”). The user selection may be received via a user interface of the vehicle (e.g., HMI 112 shown in FIG. 1), for example, in response to presenting a menu option for enabling or disabling the Automated Feature.

As shown in FIG. 2, the method 200 includes step 204, where the processor determines whether preset driving conditions required to activate the Automated Feature have been met. The preset driving conditions (also referred to herein as “preset conditions”) can include the vehicle entering a highway and merging into a preferred or stable lane of the highway (e.g., a center lane or left lane). The processor may use data obtained from one or more ECUs of the vehicle to determine whether the preset conditions have been satisfied.

For example, real-time location data obtained by a vehicle navigation system and/or real-time image data obtained by a vehicle camera system may be used to determine that the vehicle is transitioning from a city street to a highway entrance ramp, and may be used to detect when the vehicle enters a preferred highway lane, for example, upon determining that the vehicle has transitioned from a right lane to a center lane or a left lane. In some cases, lane change data may be obtained from other ECUs, such as, for example, a power steering system (e.g., power steering system 122 shown in FIG. 1) or a powertrain control module (e.g., PCM 118 shown in FIG. 1) of the vehicle computing system.

In some embodiments, an advanced driving assistance system (e.g., ADAS 114 shown in FIG. 1) may be configured to collect data from the various ECUs of the vehicle computing system, use the data to determine whether the preset conditions have been satisfied, and provide a notification to the processor if the preset conditions have been satisfied. In other embodiments, the processor may be configured to request, from the ADAS or one or more other ECUs, a notification once the conditions have been satisfied.

If the preset conditions have not been satisfied (e.g., “No”), the method 200 continues to step 206, where the processor initiates a standby mode. While in the standby mode, the processor waits for a notification indicating satisfaction of the preset conditions from one or more ECUs of the vehicle. Once the notification is received and/or the processor determines that the preset conditions have been satisfied (e.g., “Yes”), the method 200 continues to step 208.

At step 208, the processor displays, on a display, a message indicating automatic activation of the automated driver assistance feature upon completion of a countdown. For example, the message may state “Adaptive Cruise Control will automatically activate in 10 seconds.” The message may be displayed on a display screen included in an instrument panel (e.g., IP 128 shown in FIG. 1) of the vehicle or any other display screen (e.g., display(s) 130 shown in FIG. 1) of the vehicle. At step 210, the processor initiates the countdown, which may be time-based or distance-based. The countdown may be displayed on the display with the message, for example, as a dynamic counter that is continuously updated until the countdown is complete (e.g., 10, 9, 8, etc.). If no inputs or commands are received during the countdown, the automated feature will automatically activate at the end of the countdown (i.e. without any further user action).

At step 212, the processor determines whether an opt-out option (also referred to herein as a “first option”) to cancel the automatic activation has been selected. The user may select the opt-out option if he/she does not to activate the Automated Feature. In some embodiments, the opt-out option may be included in the message displayed at step 208 or otherwise presented on the display as a user-selectable option. In other embodiments, the opt-out option may be selected via an input device (e.g., one of the input devices 132 shown in FIG. 1) for cancelling the automatic activation, such as, e.g., a “Cancel” button included in the instrument panel or other portion of the human-machine interface. If the opt-out option is selected at step 212 (e.g., “Yes”), the method 200 continues to step 214, where the processor stops the countdown. From step 214, the method 200 continues back to step 206, where the processor initiates the standby mode and waits for another opportunity to activate the Automated Feature.

If the opt-out option is not selected at step 212 (e.g., “No”), the method 200 may continue to step 216, where the processor determines whether an opt-in option to start the automated feature has been selected. The user may select the opt-in option if he/she wishes to start using the automated driver assistance feature immediately. Like the opt-out option, in some embodiments, the opt-in option may be included in the message displayed at step 208 or otherwise presented on the display as a user-selectable option. In other embodiments, the opt-in option may be selected via an input device (e.g., one of the input devices 132 shown in FIG. 1) for initiating the automated feature, such as, e.g., a “Set” button or a “Resume” button included in the instrument panel or other portion of the human-machine interface.

If the opt-in option is selected at step 216 (e.g., “Yes”), the method 200 continues to step 218, where the processor stops the countdown. From step 218, the method 200 continues to step 220, where the processor activates the automated feature. If the opt-in option is not selected at step 216 (e.g., “No”), the method 200 continues to step 222, where the processor waits for completion of the countdown, and once the countdown is complete, activates the automated feature according to step 220.

In some embodiments, the automated feature activated at step 220 includes a driver assistance feature for controlling longitudinal movement of the vehicle based on vehicle surroundings data obtained from at least one ECU of the vehicle. For example, the automated feature may be an Adaptive Cruise Control (ACC) feature that is configured to accelerate or decelerate the vehicle in order to keep the vehicle at a selected speed and a predetermined distance away from any vehicle in the lane ahead. In such cases, activating the automated feature at step 220 includes setting the vehicle speed to the selected speed. In some cases, the selected speed is a value automatically selected by the vehicle system based on a speed limit associated with the highway. In such cases, the highway speed limit information may be obtained from the navigation system or a remote server via a telematics control unit (e.g., TCU 115) of the vehicle system. In other cases, the vehicle speed may be a preselected value entered by the user, stored in a vehicle memory, and retrieved by the processor upon activation of the automated feature.

In other embodiments, the automated feature activated at step 220 includes a driver assistance feature for controlling both longitudinal and lateral movement of the vehicle based on vehicle surroundings data obtained from at least one ECU of the vehicle. For example, the automated feature may be a Traffic Jam Assist (TJA) feature (also known as “ACC with stop and go”) that is configured to provide ACC-type longitudinal control, but also apply the brakes to bring the vehicle to a full stop. The TJA feature can also provide lateral control of the vehicle in the form of Lane Centering, so as to keep the vehicle within a center of the highway lane. As another example, the automated feature may be a Highway Assist (HA) feature, which may be configured to add additional lateral control, such as lane maintenance, to the longitudinal control provided by the TJA feature.

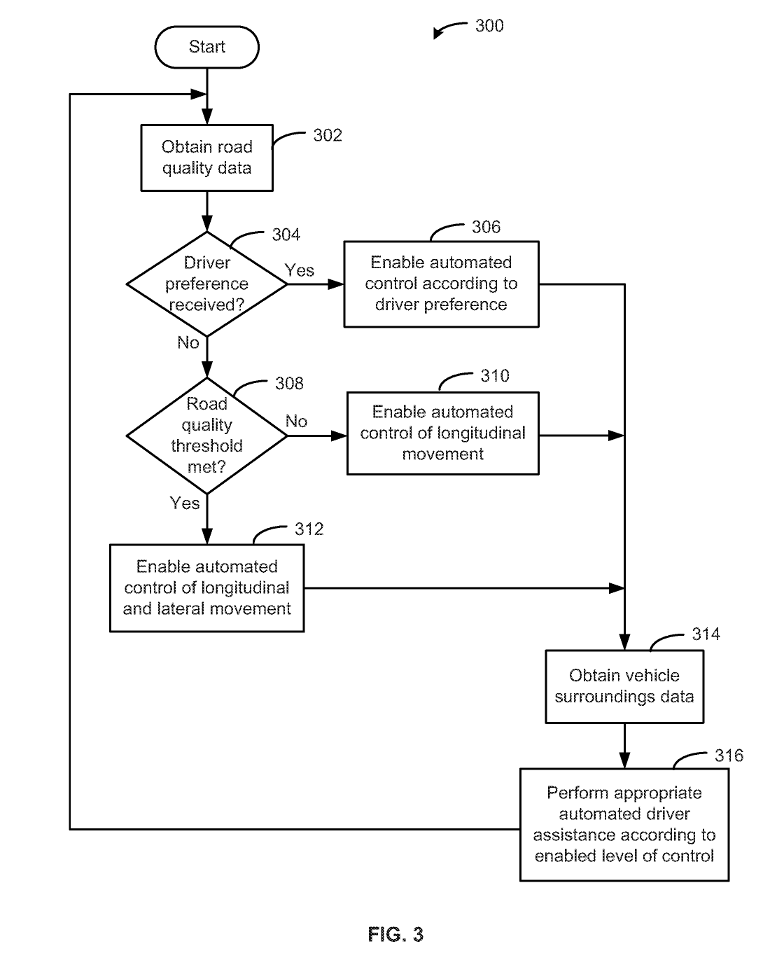

In some embodiments, activating the automated driver assistance feature at step 220 may include determining whether to control longitudinal and/or lateral movement of the vehicle based on road quality data obtained by the processor. FIG. 3 shows an exemplary method 300 for making this determination and is described in more detail below.

The vehicle surroundings data used in step 220 to control longitudinal and/or lateral movement of the vehicle may include, for example, a distance between the vehicle and any vehicle in the lane ahead and other proximity-based data for avoiding collisions or scrapes and detecting other vehicles; lane marking data to help keep the vehicle centered in the lane; and/or road curvature information to help keep the vehicle within its lane. In embodiments, the vehicle surroundings data may be received from one or more vehicle sensors (e.g., vehicle sensors 108 shown in FIG. 1), the vehicle camera system, or other ECU of the vehicle system.

In embodiments, the method 200 can further include steps related to deactivating or disabling the automated feature. For example, as shown in FIG. 2, the method 200 may include step 224, where the processor determines whether an override command has been received from one or more ECUs of the vehicle computing system. The override command may be, for example, a braking event, or an indication thereof, received from a brake control module (e.g., brake control module 124) of the vehicle computing system. As another example, the override command may be a lane change event, or an indication thereof, received from one or more ECUs, such as, e.g., the navigation system, the camera system, the body control module, the power steering system, and/or the ADAS. In some cases, activating a turn signal or turning the steering wheel to the left or right may indicate a lane change event. In other cases, the lane change event may be determined based on location data and/or image data indicating that the vehicle has changed lanes. In some cases, the override command may be an acceleration event, or an indication thereof, received from a powertrain control module (e.g., PCM 118 shown in FIG. 1). If an override command is received (e.g., “Yes”), the method 200 continues to step 226, where the processor deactivates the automated feature, and then back to step 206, where the processor resumes the standby mode until the vehicle's position stabilizes and/or the preset conditions are satisfied once again. If an override command is not received, the method 200 may continue to step 228.

At step 228, the processor determines whether the preset conditions are still satisfied, for example, by checking whether the vehicle is still traveling on the highway and is still positioned in a stable lane of the highway. The processor may determine that the preset condition is no longer met if the vehicle merges onto an exit ramp of the highway or changes lanes, for example, into an unstable lane (e.g., the right lane) of the highway). If the preset conditions are no longer satisfied (e.g., “No”), the method 200 may move to step 226, where the processor deactivates the automated feature.

If the preset conditions are still met (e.g., “Yes”), the method 200 continues to step 230, where the processor determines whether the automated feature has been disabled. The automated feature may be disabled upon user selection of an “Off” button or other input device on the instrument panel or other portion of the human-machine interface. In embodiments, the automated feature may be disabled at any time during the method 200. The method 200 may end upon receiving the user selection to disable the automated feature (e.g., “Yes” at step 230). If the answer at step 230 is “No,” the method 200 may continue back to step 224, where the processor waits for conditions that may deactivate or disable the automated feature.

Referring now to FIG. 3, shown is an example method 300 of selecting an appropriate driver assistance feature in a vehicle, in accordance with embodiments. The method 300 can be carried out by one or more processors (or controllers) included in, for example, a vehicle computing system (such as, e.g., the vehicle computing system 100 shown in FIG. 1). In one embodiment, the method 300 is implemented, at least in part, by the data processor 102 of the VCS 100 executing software stored in the data storage device 104, such as, e.g., the driver assistance module 126, and interacting with one or more components of the VCS 100, such as, e.g., the HMI 112, the ADAS 114, and/or one or more of the other ECUs. In some embodiments, the method 300 may be included in step 220 of the method 200 shown in FIG. 2.

The method 300 includes step 302, where the processor obtains road quality data from one or more ECUs, such as, for example, the vehicle camera system, the vehicle navigation system, and/or the advanced driver assistance system (ADAS). The road quality data can include lane markings information, road curvature information, and other information related to a condition of the road.

At step 304, the processor determines whether a driver preference for the level of automated control has been entered via a user interface (e.g., HMI 112) of the vehicle. For example, the driver preference can include a user selection for whether lateral control can be applied while the automated driver assistance feature is active. The driver preference can be stored in a vehicle memory (e.g., driver preference information 138 shown in FIG. 1) for future retrieval, including during future cycles of the method 300. If the answer at step 304 is “Yes,” the method 300 continues to step 306, where the processor enables automated control (e.g., lateral, longitudinal, or both) according to the driver preference. For example, if the driver preference indicates no lateral control, the driver assistance feature selected by the method 300 will be limited to the features that only include longitudinal control, such as, Adaptive Cruise Control (ACC). In some cases, the driver preference may include user selection of a specific driver assistance feature for use on highways, such as, for example, ACC, Traffic Jam Assist (TJA), or Highway Assist (HA).

If the answer at step 304 is “No,” the method 300 continues to step 308, where the processor determines whether a road quality threshold is met. The road quality threshold determines whether a driver assistance feature providing automated control of lateral movement will be activated. Specifically, if the answer at step 308 is “No,” the method 300 continues to step 310, where the processor enables automated control of longitudinal movement only. However, if the road quality threshold is met at step 308 (e.g., “Yes”), the method 300 continues to step 312, where the processor enables automated control of both lateral and longitudinal movement. As an example, the road quality threshold may include a road curvature threshold and a threshold associated with clarity of the lane markings.

From step 306, step 310, or step 312, the method 300 continues to step 314, where the processor obtains vehicle surroundings data from one or more ECUs of the vehicle system. At step 316, the processor performs an appropriate level of automated driver assistance according to the level of control enabled at step 306/310/312 and based on the vehicle surroundings data received at step 314. From step 316, the method 300 may return back to step 302 in order to continue monitoring the road quality and update the level of automated control as needed.

In some cases, the automated driver assistance feature is further selected based on an amount of hands-free time detected by the processor. For example, the Highway Assist (HA) feature may be selected if lane markings are sufficiently clear, road curvature is within a predetermined threshold, the vehicle has traveled the road enough times to develop an adequate drive history for the road, and the vehicle operator has not touched the steering wheel for a predetermined amount of time (e.g., six minutes). As another example, the Traffic Jam Assist (TJA) feature may be selected if the lane markings are sufficiently clear, the road curvature is within a predetermined threshold, and the vehicle operator has not touched the steering wheel for predetermined amount of time (e.g., 10 seconds). In some cases, the Adaptive Cruise Control feature may be automatically selected if the requirements for TJA and HA are not satisfied.

In certain embodiments, the process descriptions or blocks in the figures, such as FIGS. 2 and 3, can represent modules, segments, or portions of code which include one or more executable instructions for implementing specific logical functions or steps in the process. Any alternate implementations are included within the scope of the embodiments described herein, in which functions may be executed out of order from that shown or discussed, including substantially concurrently or in reverse order, depending on the functionality involved, as would be understood by those having ordinary skill in the art.

It should be emphasized that the above-described embodiments, particularly, any “preferred” embodiments, are possible examples of implementations, merely set forth for a clear understanding of the principles of the invention. Many variations and modifications may be made to the above-described embodiment(s) without substantially departing from the spirit and principles of the techniques described herein. All such modifications are intended to be included herein within the scope of this disclosure and protected by the following claims.

1. A vehicle system, comprising:
a display capable of displaying a message indicating automatic activation of a driver assistance feature;
at least one electronic control unit configured to determine whether preset driving conditions are met; and
a processor configured to cause the display to display the message upon receiving a notification indicating satisfaction of the conditions, initiate a countdown, and automatically activate the driver assistance feature upon completion of the countdown.

2. The vehicle system of claim 1, wherein the preset driving conditions include entering a highway and merging into a preferred lane of the highway.

3. The vehicle system of claim 1, further comprising: a user interface capable of receiving user selection of a first option to cancel the automatic activation, wherein the displayed message further indicates the first option, and the processor is further configured to stop the countdown upon receiving a selection of the first option.

4. The vehicle system of claim 3, wherein the user interface is further capable of receiving user selection of a second option to initiate the driver assistance feature, the displayed message further indicates the second option, and the processor is further configured to stop the countdown and activate the driver assistance feature upon receiving a selection of the second option.

5. The vehicle system of claim 1, wherein the processor is further configured to deactivate the driver assistance feature upon receiving a second notification indicating that the preset driving conditions are no longer satisfied.

6. The vehicle system of claim 1, wherein the processor is further configured to deactivate the driver assistance feature upon receiving an override command via the at least one electronic control unit. The vehicle system of claim 6, wherein the override command is a braking event.

8. The vehicle system of claim 6, wherein the override command is a lane change event.

9. The vehicle system of claim 6, wherein the override command is an acceleration event.

10. The vehicle system of claim 1, wherein the driver assistance feature is configured to control a longitudinal movement of a vehicle based on vehicle surroundings data obtained from the at least one electronic control unit.

11. The vehicle system of claim 10, wherein the driver assistance feature is further configured to control a lateral movement of the vehicle using the vehicle surroundings data obtained from the at least one electronic control unit.

12. The vehicle system of claim 1, wherein the driver assistance feature is configured to select whether to control longitudinal and/or lateral movement of a vehicle based on road quality data obtained from the at least one electronic control unit.

13. A method of activating a driver assistance feature in a vehicle, the method comprising:
receiving, at a processor, a notification indicating satisfaction of preset driving conditions;
in response, displaying, on a display, a message indicating automatic activation of the driver assistance feature;
initiating a countdown, using the processor; and
automatically activating the driver assistance feature, using the processor, upon completion of the countdown.

14. The method of claim 13, wherein the preset driving conditions include entering a highway and merging into a preferred lane of the highway.

15. The method of claim 13, further comprising:
receiving, via a user interface, user selection of a first option to cancel the automatic activation; and
in response, stopping the countdown using the processor.

16. The method of claim 13, further comprising:
receiving, via a user interface, user selection of a second option to initiate the driver assistance feature; and
in response, stopping the countdown and activating the driver assistance feature using the processor.

17. The method of claim 13, further comprising:
receiving, at the processor, a second notification indicating that the preset driving conditions are no longer satisfied; and
in response, deactivating the driver assistance feature using the processor.

18. The method of claim 13, further comprising:
receiving, at the processor, an override command; and
in response, deactivating the driver assistance feature using the processor.

19. The method of claim 18, wherein the override command is at least one of a braking event, a lane change event, or an acceleration event of the vehicle.

20. The method of claim 13, wherein the driver assistance feature is configured to determine whether to control longitudinal and/or lateral movement of the vehicle based on road quality data obtained by the processor.
